(19) United States
(12) Patent Application Publication
(10) Pub. No.: US 2016/0303473 A1
(43) Pub. Date: Oct. 20, 2016

(54) Driving Game Seat Apparatus

(71) Applicant: More Profit International Development Limited, Kowloon (HK)

(72) Inventor: Lai Man CHEUNG, Kowloon (HK)

(21) Appl. No.: 15/098,547

(22) Filed: Apr. 14, 2016

(30) Foreign Application Priority Data
Apr. 14, 2015 (HK) 15103631.2

(51) Int. Cl. A63F 13/245; A63F 13/285; A47C 3/00; A47C 1/00; A47C 7/56

(52) U.S. Cl. CPC A63F 13/245; A47C 1/00; A47C 7/56; A47C 3/00; A63F 13/285

(57) ABSTRACT

Driving game seat apparatus (100) for use with a screen (20) and a video game console (10) running a driving game, has a base structure (200), a seat (300) provided on the base structure for a player, and a drive control mechanism (400) provided on the base structure at a forward position relative to the seat. The drive control mechanism has a steering module (410), an accelerating module (420) and a braking module (430) for steering, accelerating and braking operations respectively. There are three actuating devices (500) connected at spaced-apart positions to the base structure and supporting the base structure for movement. Also included is a control circuit (600) for use with the game console and associated with the drive control mechanism for, in response to the operation of the steering, accelerating and braking modules, controlling the actuating devices to move and set the base structure in motion.

The present invention relates to driving game seat apparatus for use with a screen and a video game console running a driving game.

### BACKGROUND OF THE INVENTION

Driving game seat apparatuses of the type concerned which sets a player in driving motions are in general known but their constructions are typically complicated.

The invention seeks to mitigate or at least alleviate such a problem or shortcoming by providing new or otherwise improved driving game seat apparatus.

### SUMMARY OF THE INVENTION

According to the invention, there is provided driving game seat apparatus for use with a screen and a video game console running a driving game, comprising a base structure, a seat provided on the base structure, on which a said player is to sit, and a drive control mechanism provided on the base structure at a forward position relative to the seat. The drive control mechanism comprises a steering module, an accelerating module and a braking module for steering, accelerating and braking operations, respectively. There are at least three actuating devices connected at spaced-apart positions to the base structure and supporting the base structure for movement. Also included is a control circuit for use with a said game console and associated with the drive control mechanism for, in response to the operation of the steering module, the accelerating module and the braking module, controlling the actuating devices to move and set the base structure in motion, thereby simulating driving experience for a said player relative to a said screen.

Preferably, the spaced-apart positions are in a triangular arrangement.

More preferably, the spaced-apart positions are either one of front and rear positions and both left and right positions relative to the base structure.

Further more preferably, the base structure has a front portion and rear left and rear right portions to which said at least three actuating devices are connected respectively.

In a preferred embodiment, at least one of the actuating devices comprises an AC motor, a support member and a drive transmission mechanism in drive engagement between the AC motor and the support member for transmitting drive from the AC motor to the support member, the support member being extendable and retractable upon operation of the AC motor to move the base structure in opposite directions.

More preferably, the drive transmission mechanism includes an externally screw-threaded member and an internally screw-threaded member in screwing engagement with each other for extending and retracting the support member.

Further more preferably, the support member is connected with the internally screw-threaded member for movement therewith.

Yet further more preferably, the support member and the externally screw-threaded member are both elongate and are in telescopic inter-engagement.

It is preferred that said at least one actuating device includes a tubular case which encases the externally screw-threaded member and from which the support member is extendable.

It is preferred that the drive transmission mechanism includes a first gear and a second gear in drive inter-engagement, with the first gear driven by the AC motor and the second gear connected with one of the externally screw-threaded member and internally screw-threaded member.

### BRIEF DESCRIPTION OF DRAWINGS

The invention will now be more particularly described, by way of example only, with reference to the accompanying drawings, in which:

FIG. 1 is a left side view of an embodiment of driving game seat apparatus in accordance with the invention;

FIG. 2 is a top plan view of the driving game seat apparatus of FIG. 1;

FIG. 3 is a front end view of the driving game seat apparatus of FIG. 1;

FIG. 4 is a rear end view of the driving game seat apparatus of FIG. 1;

FIGS. 5A, 5B, and 5C are cross-sectional left side views of a seat of the driving game seat apparatus of FIG. 2, taken along line V-V, in the course of an adjustment of the seat by the player from a forward position to a more suitable rearward position to fit the player;

FIG. 6 is a cross-sectional side view of an actuating device of the driving game seat apparatus of FIG. 1;

FIG. 7 is a cross-sectional side view corresponding to FIG. 6, showing the actuating device in an extended condition;

FIGS. 8 and 9 are front end views of the driving game seat apparatus of FIG. 1, showing the driving game seat apparatus being set in right-turn and left-turn motions respectively;

FIGS. 10 and 11 are left side views of the driving game seat apparatus of FIG. 1, showing the driving game seat apparatus being set in acceleration and braking motions respectively; and

FIG. 12 is a functional block diagram representing the driving game seat apparatus of FIG. 1, showing its general configuration including a control circuit and its operation.

### DETAILED DESCRIPTION OF PREFERRED EMBODIMENT

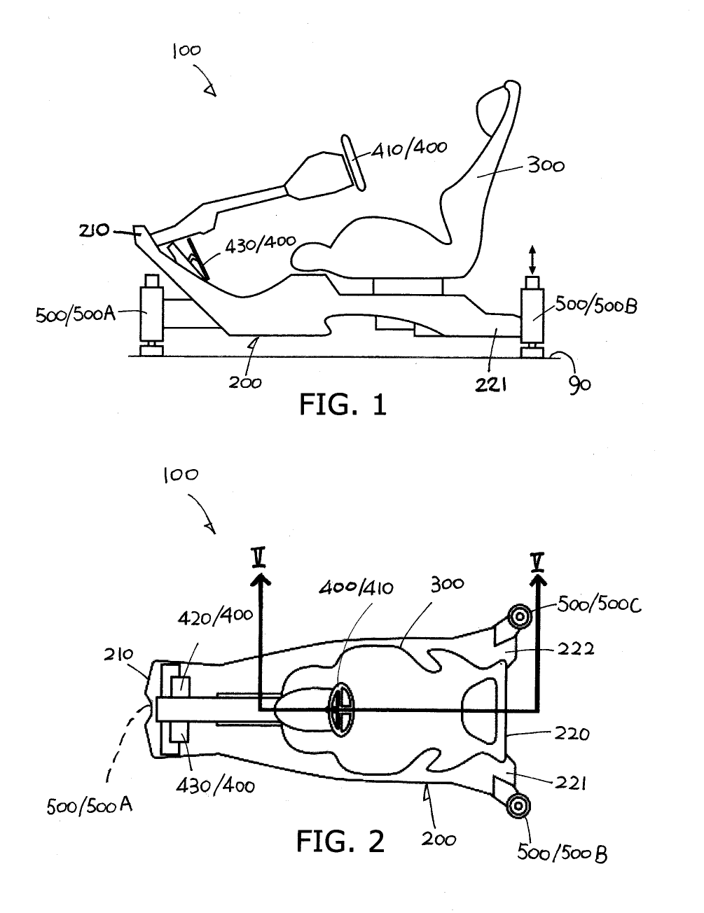

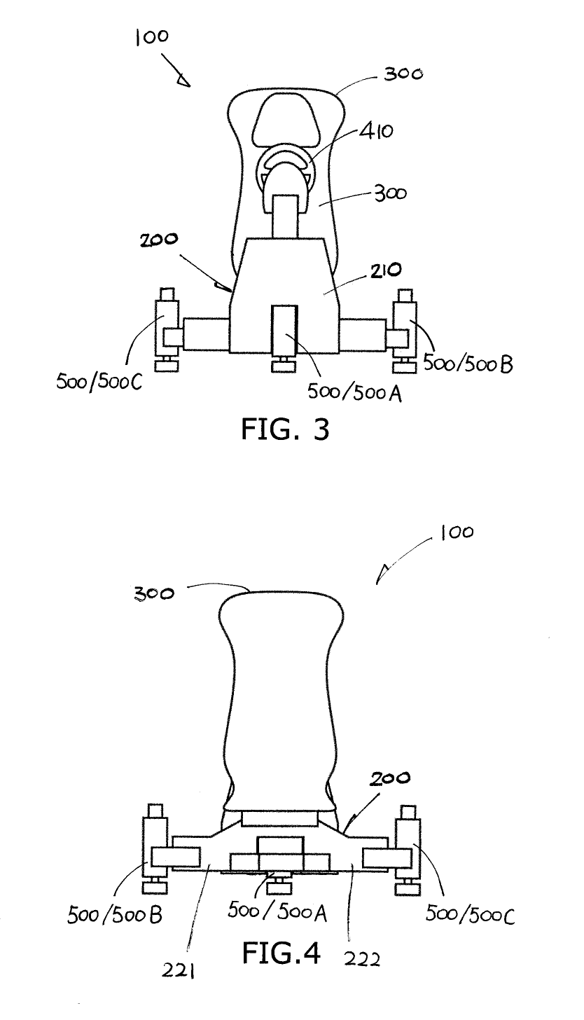

Referring to FIGS. 1 to 12 of the drawings, there is shown driving game seat apparatus 100 for use with a screen 20 and a video game console 10 running a driving game, such as a car driving game, embodying the invention, which driving game seat apparatus 100 has a base structure 200, a seat 300 provided on the base structure 200, on which a player is to sit, and a drive control mechanism 400 provided on the base structure 200 at a forward position relative to the seat 300. The drive control mechanism 400 comprises a steering module 410, an accelerating module 420 and a braking module 430 for performing steering, accelerating and braking actions respectively, which are preferably implemented in the form of a steering wheel 410, an accelerator pedal 420 and a brake pedal 430 as in a car. These modules are connected to the game console 10, and together act as a game controller for the player to play the driving game.

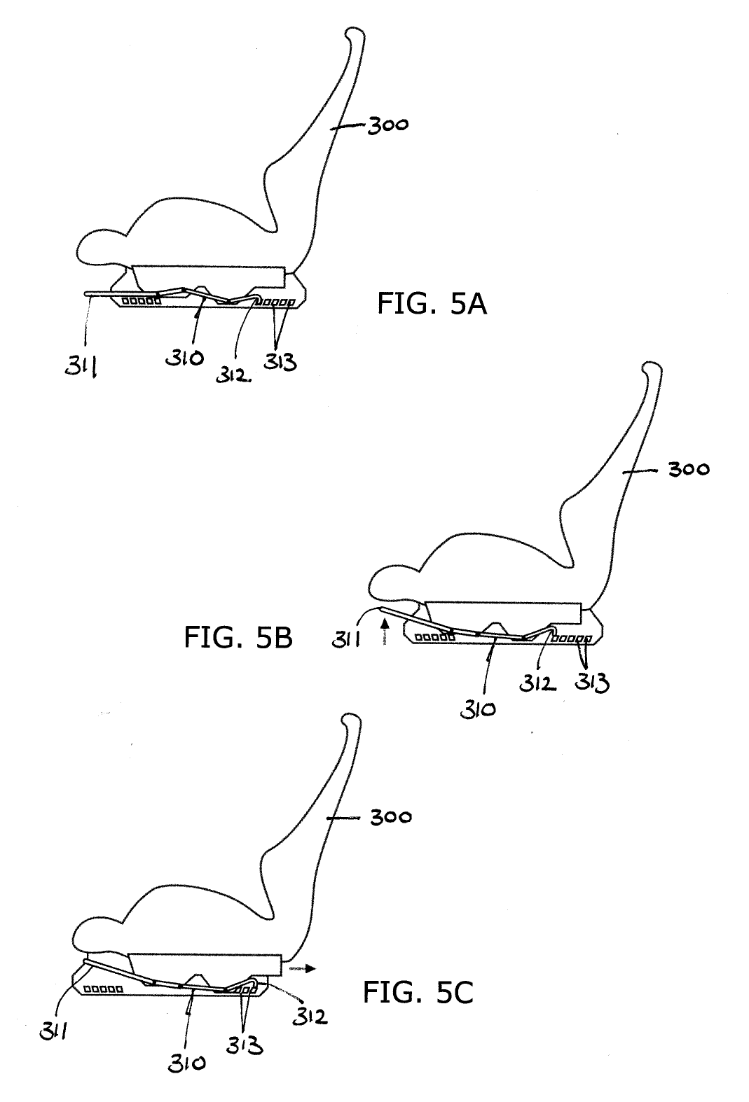

FIGS. 5A, 5B, and 5C are cross-sectional left side views of a seat of the driving game seat apparatus of FIG. 2, taken along line V-V. The seat 300 is located on the base structure 200 by means of a mechanism that permits the seat's position to be adjusted forward and backward to fit the player. As shown in FIG. 5A, the mechanism includes a linkage 310 underneath the seat 300, which has a front handle 311 and a rear hook 312 that is engageable selectively with one of a series of holes 313 to fix the position of the seat 300. As shown in FIG. 5B, by using the handle 311 to release and re-engage the hook 312, the player may slide the seat 300 to a suitable position, as shown in FIG. 5C, for manipulating the steering wheel 410 and pedals 420 and 430.

The driving game seat apparatus 100 includes at least three or, in this particular embodiment, three actuating devices 500 (i.e. 500A, 500B and 500C) connected at spaced-apart positions to the base structure 200 and supporting the base structure 200 for movement. Also included is a control circuit 600 for use with the game console 10 and associated with the drive control mechanism 400 for, in response to the operations of the steering module 410, the accelerating module 420 and the braking module 430, controlling the actuating devices 500 to move and set the base structure 200 in motion, thereby simulating driving experience for a player relative to the screen 20.

The base structure 200 is placed horizontally on or close to a floor 90, having a generally flat triangular shape with a front portion 210 and a relatively wider rear portion 220 which in turn has a rear left portion 221 and a rear right portion 222. The actuating devices 500A, 500B and 500C are connected to the front portion 210 and the rear left and rear right portions 221 and 222 respectively, at the aforesaid spaced-apart positions which are in a triangular arrangement. Each actuating device 500A/500B/500C has a slender elongate configuration and is arranged to extend or stand vertically like a leg.

More specifically, the actuating devices 500A, 500B and 500C are used to support, and in particular to move and adjust the upward/downward position of, the respective front, left and right portions 210, 221 and 222 of the base structure 200. They are hereinafter also referred to as the front, left and right actuating devices 500A, 500B and 500C. The left and right actuating devices 500B and 500C, being deployed at the rear, are also operable in combination to adjust the upward/downward position of the rear portion 220 of the base structure 200.

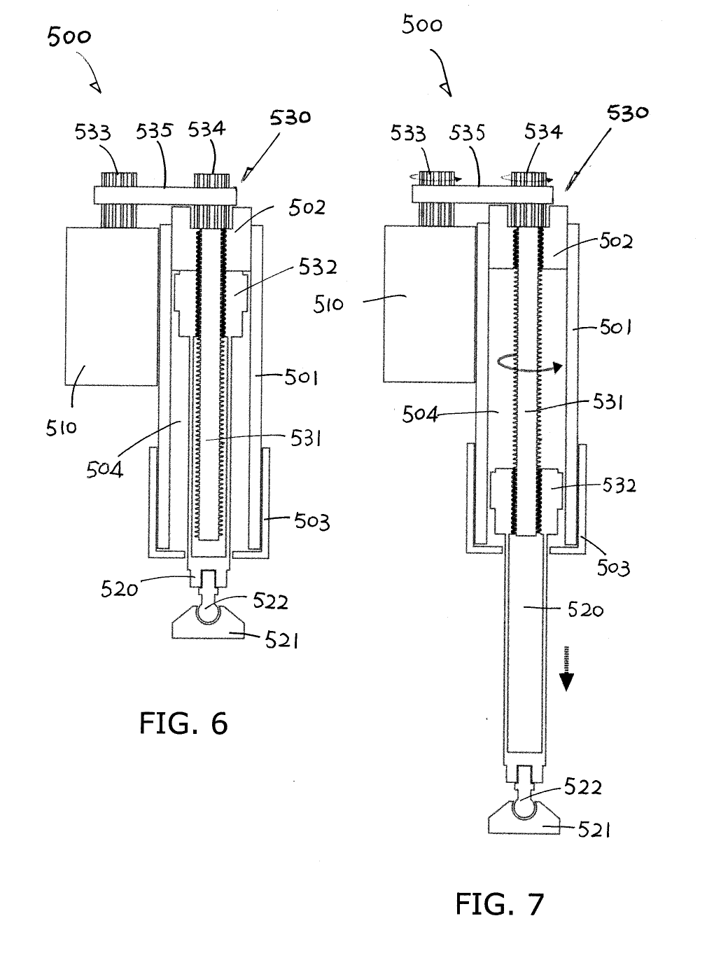

The three actuating devices 500 share generally the same construction in this particular embodiment, though it is to be noted that they may be of different constructions, for example as between the front actuating device 500A and the rear left and right actuating devices 500B and 500C. Although the construction described below is generally applicable to all three actuating devices 500A to 500C (FIGS. 6 and 7), whose constituent components are where appropriate differentiated by respective suffix letters A, B or C in their reference numerals, it may be applicable to at least one of the actuating devices 500.

Each actuating device 500 has a tubular case 501, by which it is secured to the base structure 200 in a vertical orientation. The actuating device 500 is formed by an AC AC motor 510 (i.e. 510A, 510B or 510C), a support member 520 and a drive transmission mechanism 530 in drive engagement between the AC motor 510 and the support member 520 for transmitting drive from the AC motor 510 to the support member 520. The support member 520 is preferably provided by an elongate cylindrical hollow rod 520 which is extendable and retractable upon operation of the AC motor 510 to move the base structure 200 in opposite directions, that being upward and downward directions. The support rod 520 is provided at its lower end with a generally conical foot 521 connected thereto by means of a ball-and-socket joint 522.

The drive transmission mechanism 530 includes an externally screw-threaded member 531 which is preferably provided by an elongate cylindrical screw 531, and also an internally screw-threaded member 532 which is preferably provided by a square or hexagonal nut 532. The screw 531 and the nut 532 are in screwing engagement with each other for, upon relative turning, extending and retracting the support rod 520. The support rod 520 is co-axially connected with or is preferably co-axially integrally formed with the nut 532 for movement therewith along a common axial direction.

The tubular case 501 centrally and co-axially encases the screw 531, both sharing a common central axis and extending over generally the same length. The support rod 520 and the screw 531 are in telescopic inter-engagement, in that the support rod 520 (which is tubular) is disposed co-axially over the screw 531. With the nut 532 being located inside the case 501, the support rod 520 is extendable centrally and co-axially from the lower end of the case 501.

The tubular case 501 is provided with a cylindrical bearing 502 fitted within the case's upper end and a cylindrical end cap 503 fitted over the case's lower end. The bearing 502 locates the screw 531 by its upper end for free rotation. The end cap 503 has a central hole through which the support rod 520 is extendable out vertically downwards. The end cap 503 locates the lower end of the screw 531 indirectly by means of the support rod 520. The nut 532 is located within an annular cavity 504 between the case 501 and the screw 531. Upon rotation of the screw 531, which extends through the nut 532 by way of screw-thread engagement, the nut 532 is slidable downwardly and upwardly along the length of the cavity 504 to thereby extend and retract the support rod 520 relative to the case 501.

The AC motor 510 is mounted on one side at the upper end of the tubular case 501, with the motor shaft pointing vertically upwards. The drive transmission mechanism 530 includes a first gear 533 and a second gear 534 in drive inter-engagement by means of a toothed belt 535, with the first gear 533 mounted fast on the motor shaft and thus driven by the motor 510 and the second gear 534 connected co-axially with the upper end of the screw 531 for in turn rotating the screw 531.

In operation, the actuating device 500 will extend its support rod 520 to raise the relevant portion 210/221/222 of the base structure 200 upon the AC motor 510 rotating in one direction (e.g. anti-clockwise as seen from above in FIG. 7) or retract the support rod 520 to lower the said base structure portion when the motor 510 reverses in the opposite direction.

The AC motors 510 are preferably provided by respective servo motors which are controlled by AC servo signals derived from respective pulse signals for the left and right motors 510B and 510C and a level signal for the front motor 510A. The AC motors 510 act similar to stepper motors for adjusting, with precision, the corresponding actuating devices 500 and in particular their length i.e. the positions of their support rods 520 extended/retracted to.

Referring also to the drive control mechanism 400, the steering wheel 410 is adapted to output, upon turning by a player, a left or right pulse signal with the number of pulses in the signal dependent upon the angle through which the steering wheel 410 is turned and the width of the pulses representing the turning direction i.e. to the left or right. The accelerator pedal 420 and brake pedal 430 are each adapted to output a level signal whose level or magnitude is determined by the extent to which the pedal 420/430 is stepped down by the relevant right/left foot of the player.

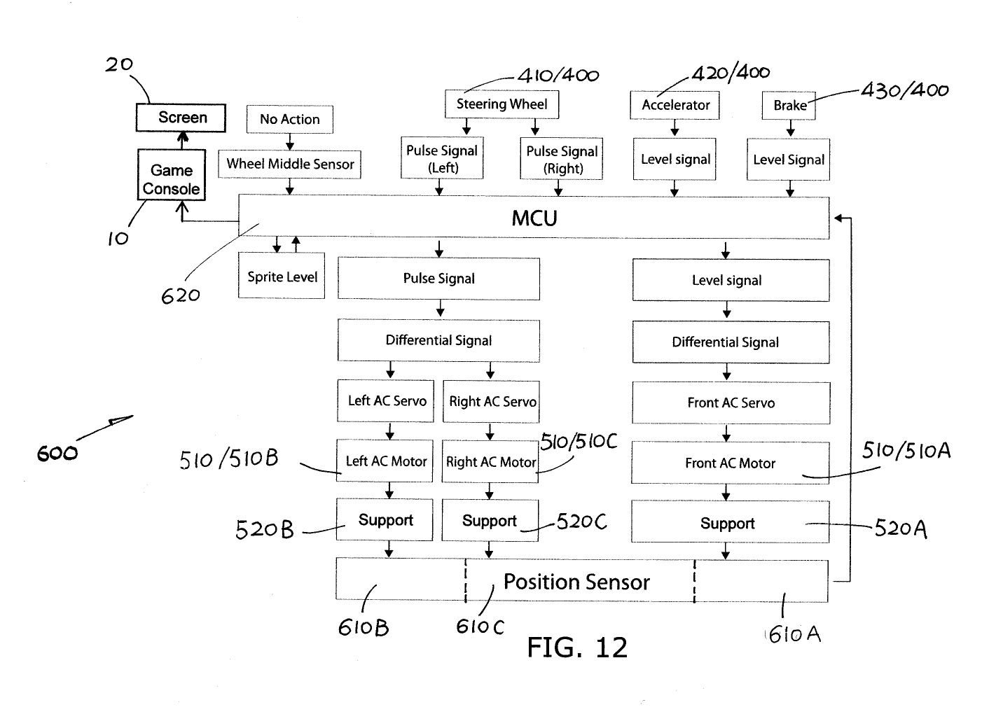

The control circuit 600 has a microprocessor-based control unit or MCU 620 to perform various signal processing functions, and includes three position sensors 610A to 610C for sensing the angular position of the AC motors 510A to 510C respectively (FIG. 12). The MCU 620 is programmed, inter alia, to convert the aforesaid pulse and level signals received from the drive control mechanism 400 into respective AC servo signals for operating the AC motors 510. The MCU 620 also performs error correction, wherever necessary on a real-time basis, for each of the AC motors 510 based on the output of the respective position sensor 610A/610B/610C, which provides a feedback signal for the MCU 620 to adjust, via said error correction, the respective AC servo signal and hence respective AC motor 510 to the desired angular position, which in turn determines the length of the corresponding actuating device 500.

The steering wheel 410, the accelerator pedal 420 and the brake pedal 430 are connected, via the MCU 620, to the game console 10 for use by a player in playing a driving game. As is apparent from the foregoing description, the front, left and right actuating devices 500A, 500B and 500C are responsible to determine the position of the front, left and right portions 210, 221 and 222 of the base structure 200 respectively.

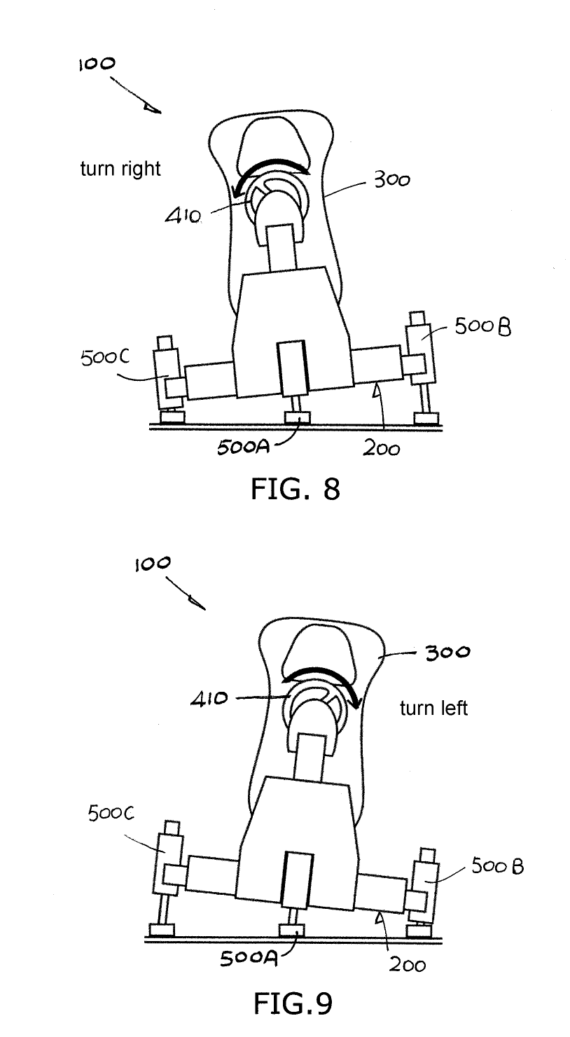

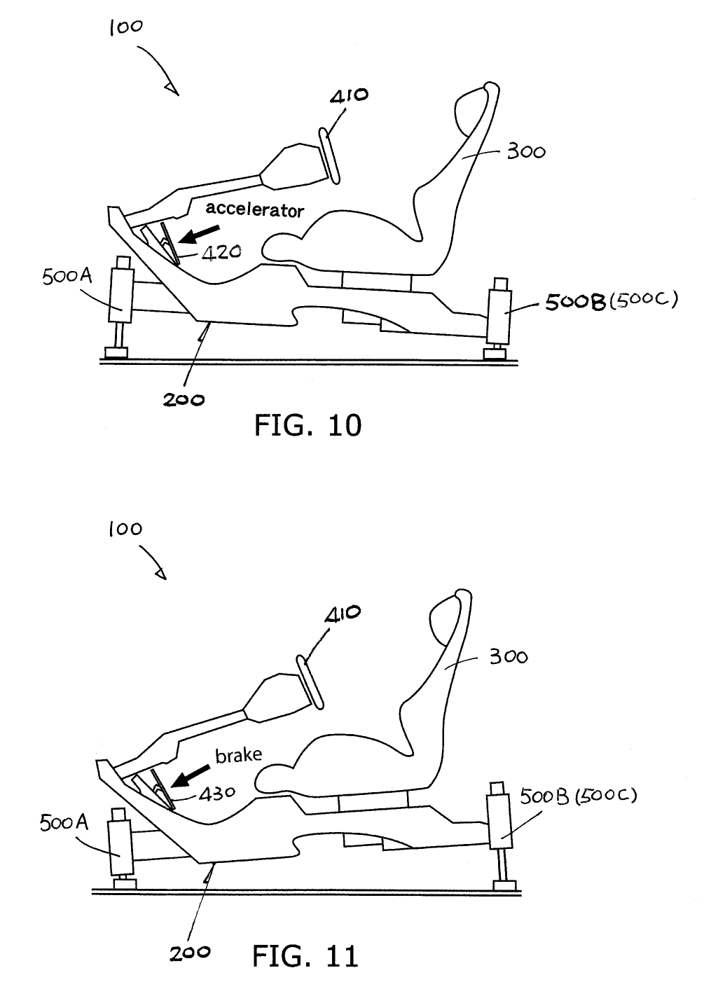

Upon a player turning the steering wheel 410 to the right, the left actuating device 500B will extend under the control of the MCU 620, thereby inclining the base structure 200 and hence the seat 300 to the right to simulate a right-turn motion (FIG. 8). As the player turns the steering wheel 410 to the left, the right actuating device 500C instead will extend under the control of the MCU 620, thereby leaning the base structure 200 and hence the seat 300 to the left to simulate a left-turn motion (FIG. 9). When the player steps on the accelerator pedal 420, the front actuating device 500A will extend under the control of the MCU 620, thereby tilting the base structure 200 and hence the seat 300 up (i.e. rear down) to simulate an acceleration motion (FIG. 10). As soon as the player applies the brake pedal 430, both the left and right actuating devices 500B and 500C instead will extend under the control of the MCU 620, thereby dipping the base structure 200 and hence the seat 300 down (i.e. rear up) to simulate a braking or slowing down motion (FIG. 11).

The extent to which the relevant actuating device(s) 500 extends or lengthens is dependent upon the angle through which the steering wheel 410 is turned or the depth to which either pedal 420/430 is applied.

The driving game seat apparatus of the subject invention has a relatively simple construction, which is also effective in simulating driving motions or experience.

It is envisaged that the spaced-apart positions at which at least three said actuating devices are arranged may in general be either one of front and rear ends and both left and right sides of the base structure. Also, more than three actuating devices are anticipated, for example four actuating devices may be employed in which case they are arranged at front left, front right, rear left and rear right positions or at front, rear, left and right positions.

It is further envisaged the driving game seat apparatus may be applied to video driving games other than a car driving game, such as a video game for driving a motor bike or an airplane.

The invention has been given by way of example only, and various other modifications of and/or alterations to the described embodiment may be made by persons skilled in the art without departing from the scope of the invention as specified in the appended claims.

1. Driving game seat apparatus for use with a screen and a video game console running a driving game, comprising:
a base structure;
a seat provided on the base structure, on which a said player is to sit;
a drive control mechanism provided on the base structure at a forward position relative to the seat, the drive control mechanism comprising a steering module, an accelerating module and a braking module for steering, accelerating and braking operations respectively;
at least three actuating devices connected at spaced-apart positions to the base structure and supporting the base structure for movement; and
a control circuit for use with a said game console and associated with the drive control mechanism for, in response to the operation of the steering module, the accelerating module and the braking module, controlling the actuating devices to move and set the base structure in motion, thereby simulating driving experience for a said player relative to a said screen.

2. The driving game seat apparatus as claimed in claim 1, wherein the spaced-apart positions are in a triangular arrangement.

3. The driving game seat apparatus as claimed in claim 2, wherein the spaced-apart positions are either one of front and rear positions and both left and right positions relative to the base structure.

4. The driving game seat apparatus as claimed in claim 3, wherein the base structure has a front portion and rear left and rear right portions to which said at least three actuating devices are connected respectively.

5. The driving game seat apparatus as claimed in claim 1, wherein at least one of the actuating devices comprises an AC motor, a support member and a drive transmission mechanism in drive engagement between the AC motor and the support member for transmitting drive from the AC motor to the support member, the support member being extendable and retractable upon operation of the AC motor to move the base structure in opposite directions.

6. The driving game seat apparatus as claimed in claim 5, wherein the drive transmission mechanism includes an externally screw-threaded member and an internally screw-threaded member in screwing engagement with each other for extending and retracting the support member.

7. The driving game seat apparatus as claimed in claim 6, wherein the support member is connected with the internally screw-threaded member for movement therewith.

8. The driving game seat apparatus as claimed in claim 7, wherein the support member and the externally screw-threaded member are both elongate and are in telescopic inter-engagement.

9. The driving game seat apparatus as claimed in claim 6, wherein said at least one actuating device includes a tubular case which encases the externally screw-threaded member and from which the support member is extendable.

10. The driving game seat apparatus as claimed in claim 6, wherein the drive transmission mechanism includes a first gear and a second gear in drive inter-engagement, with the first gear driven by the AC motor and the second gear connected with one of the externally screw-threaded member and internally screw-threaded member.
